(19) United States
(12) Patent Application Publication
(10) Pub. No.: US 2005/0124383 A1
(43) Pub. Date: Jun. 9, 2005

(54) Wireless device for communicating with a RIS workstation

(75) Inventor: Sean Booth, St. Peters Bay (CA)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/834,703

(22) Filed: Apr. 29, 2004

Related U.S. Application Data
(60) Provisional application No. 60/525,218, filed on Nov. 26, 2003.

(51) Int. Cl. H04M 1/00

(52) U.S. Cl. 455/557

(57) ABSTRACT

A wireless device and method for communicating dictation. The device and method are particularly suited for use with a RIS workstation. The system comprises a wireless communication device and a computer in wireless communication with the wireless communication device. The computer is adapted to receive a plurality of data packets from the wireless communication device representative of portions of a dictation. The computer assembles the plurality of data packets received from the wireless communication device into a wave file representative of the dictation.

### CROSS REFERENCE TO RELATED APPLICATION

This is a 111a of U.S. Provisional Patent Application No. 60/525,218 filed on Nov. 26, 2003, incorporated herein by reference.

### FIELD OF THE INVENTION

The invention relates generally to the field of health imaging, and in particular to a device which can communicate with a Radiology Information System (RIS) system.

### BACKGROUND OF THE INVENTION

A doctor or other medical personnel often makes notes regarding their patients. Often, such notes become part of a patient's chart. There exists a need to provide a system and method for allowing a doctor to readily communicate with a RIS workstation.

### SUMMARY OF THE INVENTION

An object of the present invention is to provide a device for communicating with a RIS workstation.

Another object of the present invention is to provide a wireless device and method for communicating dictation

According to one aspect of the present invention, there is provided a system comprising a wireless communication device and a computer in wireless communication with the wireless communication device. The computer is adapted to receive a plurality of data packets from the wireless communication device representative of portions of a dictation. The computer assembles the plurality of data packets received from the wireless communication device into a wave file representative of the dictation.

According to another aspect of the present invention, there is provided a method of dictation. The method includes the steps of: 1) transmitting connection data from a wireless communications device of the user to a remote computer; 2) accepting a portion of the dictation of a user using the wireless communications device; 3) transmitting the accepted portion of the dictation from the wireless communications device to the remote computer; 4) repeating steps 2 and 3 until the dictation has been transmitted to the remote computer; and 5) assembling the plurality of portions received by the remote computer into a wave file representative of the dictation.

This object is given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

### BRIEF DESCRIPTION OF THE DRAWINGS

The foregoing and other objects, features, and advantages of the invention will be apparent from the following more particular description of the preferred embodiments of the invention, as illustrated in the accompanying drawings.

FIG. 1 shows a system in accordance with the present invention.

FIG. 2 shows the system of FIG. 1 in communication with a network.

FIG. 3 shows a table listing some properties for communication with the device of the present invention.

FIG. 4 shows a table listing some methods for communication with the device of the present invention.

FIG. 5 shows a table listing some events for communication with the device of the present invention.

FIG. 6 shows exemplary communication methods suitable for use with the present invention.

FIG. 7 generally illustrates use of the device of the present invention.

FIG. 8 shows an ice cube tray generally illustrating an analogy for the transmission and assembly of the plurality of portions of dictation.

FIGS. 9-11 show the display of the device of the present invention illustrating various features of the device.

### DETAILED DESCRIPTION OF THE INVENTION

The following is a detailed description of the preferred embodiments of the invention, reference being made to the drawings in which the same reference numerals identify the same elements of structure in each of the several figures.

The invention of the present invention relates to a wireless enabled device, suitable for use by a doctor or other medical professional (i.e., a user), which can communicate with a remote system, such as a personal computer, Radiology Information System (RIS) system/workstation, or the like. FIG. 1 shows an exemplary device 10 adapted to communicate to a RIS workstation 12 by means of a wireless technology 14. Wireless technologies can include, but are not limited to, wireless TCPIP, file transfer, and the like.

As illustrated in FIG. 1, device 10 is a discrete device separate from RIS workstation 12 and is preferably compact in size and of a weight suitable to be held in a user's hand. Device 10 can be a personal digital assistant (PDA) or the like equipped with a wireless network card, which communicates with RIS workstation 12. Device 10's communication with RIS workstation 12 preferably does not require the use of a cradle for data transfer. RIS workstation 12 may include speakers to listen to dictations, as will become apparent below. An example of device 10 is an iPaq.

Device 10 is adapted for wireless dictation. More particularly, device 10 is configured to perform real-time dictation, preferably in real-time with no delay from the time of completion of the dictation to using the dictation in the RIS workstation software or proceeding to record subsequesnt dictation. Device 10 is also preferably configured to allow the doctor to be able to Start/Stop/RW/FF recording/dictation from device 10. A selection member 16, such as a button shown in FIG. 1, can be employed to provide such a feature. Once recorded, the recorded dictation can then be transcribed, approved, and signed by the doctor. A paper copy of the transcript might then be placed in the patient's folder/records.

Device 10 is also preferably configured to perform patient navigation on RIS workstation 12 such that a doctor or other medical professional can move from one patient's record to another without the need of touching RIS workstation 12. The information displayed on the RIS workstation's display would be viewable by the doctor on a display 18 of device 10, or the RIS workstation can be configured to only display the requested information (i.e., the information accessed) on display 18. Such patient navigation can include the ability to scroll in the patient history list in a Preparation window and to switch between tab pages in the Preparation window.

Device 10 can be configured to record dictation in real-time and simultaneously transfer the dictation to RIS workstation 12. The dictation would be split into many small data-packets. As the data packets are filled with recorded data, they can be transferred to RIS workstation 12 by means of a file transfer. RIS workstation 12 can then assemble the data-packets and create a single wave file containing the dictation. The data-packets are preferably of a suitable size so as to be readily transferable to RIS workstation 12. With the data packets of a suitable (small) size and the recording being accomplished in a different process thread, the dictation recording should not exhibit any pauses.

Device 10 preferably includes a high memory capacity since the dictations may be quite large, potentially 5 MB per minute.

The present invention can be configured such that once the dictation has been transferred to RIS workstation 12 and the Doctor has moved to another dictation, the recording can be navigated/played on RIS workstation 12 only.

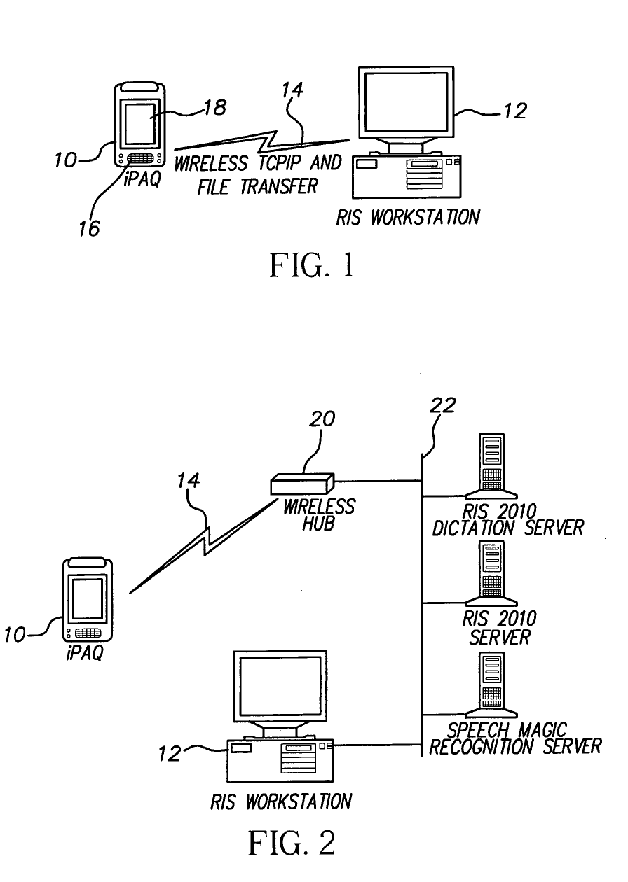

Communication with RIS workstation 12 is preferably accomplished by means of a wireless network card. Such a wireless network card can be embedded in device 10 and can communicate with a wireless network hub 20, as shown in FIG. 2. Using a wireless network card and network hub 20, device 10 can connect by means of a TCPIP socket 22 to RIS workstation 12 and exchange data. For optimal performance, it is suggested that wireless hub 20 be sufficiently close to the user performing the dictation, perhaps even in the same room depending on the electrical interference in the hospital or medical facility.

A TCPIP port enables communication messages to be sent to RIS workstation 12 allowing the doctor/user to navigate by means of selection member(s) 16 (e.g., a button) on device 10. This allows the doctor to scroll through a patient list without touching (i.e., physical contact) with RIS workstation 12.

Recording the dictation in small data-packets allows the user to scroll through the dictation and play it back. Should the user wish to alter their recorded dictation, they can record over top of the existing dictation. With proper management, only the small data-packets that are altered need to be re-transferred to RIS workstation 12, thereby allowing for continued real-time recording.

The application software controlling/operating device 10 can be configured to reduce/eliminate the number of clicks or buttons required for operation of device 10. For example, the dictatation can be initiated by pressing/touching selection member 16 configured as a record button.

Application software for device 10 control/operates/handles the real-time recording and communication with RIS workstation 12. This applcation software can be written, for example, in Microsoft Embedded Visual Basic.

RIS workstation 12 might include a Diagnostic module user interface. If such a Diagnostic module of RIS workstation 12 includes a recording function, operation of the RIS workstation's existing recording function can be suspended or temporarily inactivated while wireless recording using device 10 is occuring. An icon, for example a wireless recording icon, can be displayed on RIS workstation 12's display'(and/or display 18) as a notification of the operation of device 10 with RIS workstation 12.

The implementation includes two components: an ActiveX embedded into the RIS workstation diagnostic module and a software application which operates on device 10.

ActiveX provides for communicate with device 10's software application. This ActiveX control can be embedded into any ActiveX container, such as the RIS workstation's application which, as indicated above, can be written in Microsoft Visual Basic. The ActiveX control communicates with the RIS workstation's application via properties methods and events.

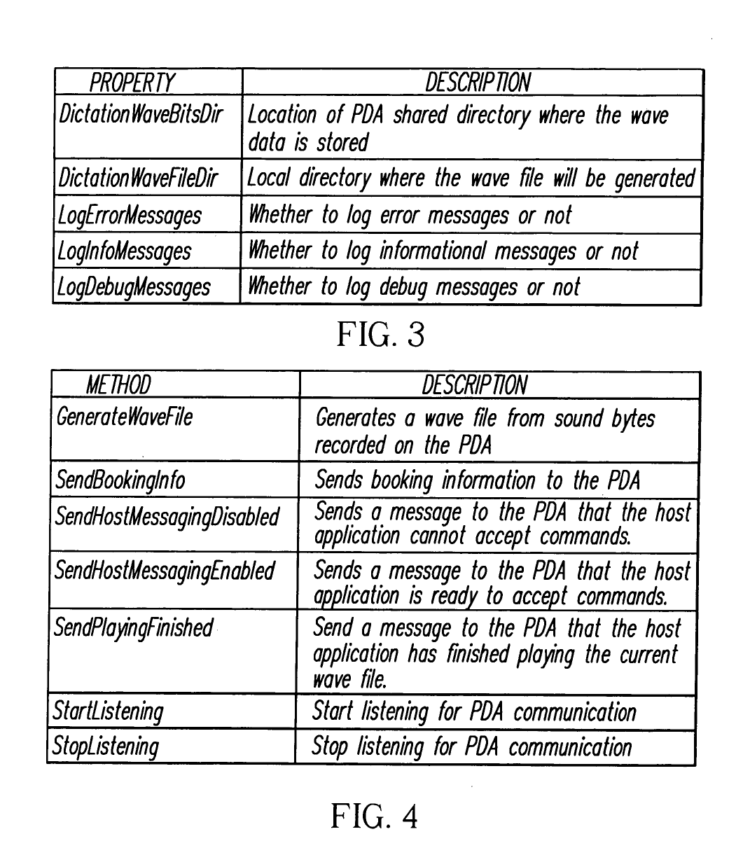

Properties of the ActiveX control are listed in FIG. 3 and are now more particularly described.

DictationWaveBitsDir includes a string which points to the directory where device 10 will deposit sound bytes. Device 10 similarly points to this directory as well.

DictaftonWaveFileDir includes a string which points to a local directory where the sound bytes will be compiled into a wave file. Typically this directory is a local temporary directory.

LogErrorMessages identifies whether or not the ActiveX control will fire log messages of the type error. Preferably the error event will be fired if an error occurs.

LoglnfoMessages identifies whether or not the ActiveX control will fire log messages of the type info.

LogDebugMessages identifies whether or not the ActiveX control will fire log messages of the type debug.

Methods of the ActiveX control are listed in FIG. 4 and are now more particularly described.

GenerateWaveFile is called when the RIS workstation application wants to generate a wave file from the sound bytes passed to it by device 10. Typically this method is called when a StopRecoding event is fired. The GenerateWaveFile method is configured to generate the wave file whether it is a standard recording, an Insert recording or an overwrite recording.

SendBookingInfo is called when the RIS workstation application wants to send information pertaining to the current booking.

SendHostMessagingDisabled is called when the RIS workstation application wants to remain connected to devic 10 but wants to disable any remote navigation or wave functionality.

SendhostMessagingEnabled is called when the RIS workstation application wants to remain connected to device 10 and wants to any remote navigation or wave functionality.

SendPlayingFinished is called when the RIS workstation application is playing a dictation locally and it has terminated. A message is sent to devic 10 to indicate to it that the RIS workstation is no longer playing the dictation.

StartListening is called when the RIS workstation application want to open a communication channel for device 10 to connect to.

StopListening is called when the RIS workstation application wants to stop listening for device 10 connections. The method will close the communications channel with device 10.

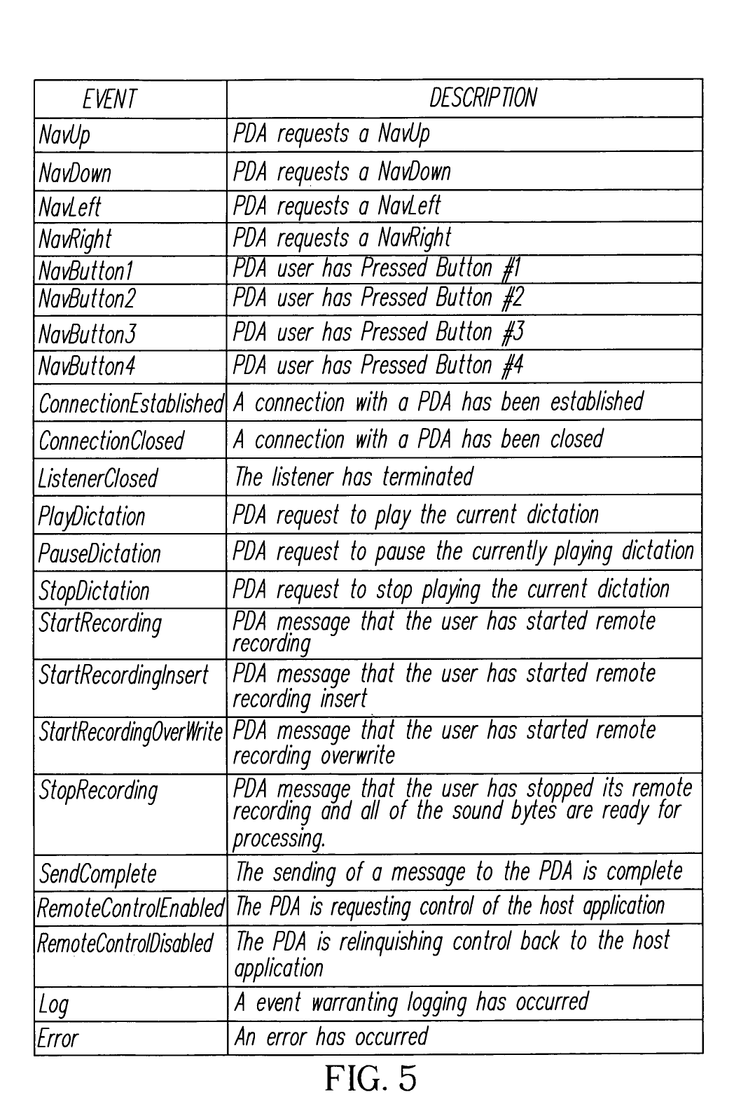

ActiveX communicates to the RIS workstation application by means of a series of events. These events are fired based on communication from device 10 and from internal ActiveX functionality. The events are listed in FIG. 5 and are now more particularly described.

With regard to the NavUp event, device 10 has sent a message indicating that the remote user has requested that the RIS workstation application navigate up one record.

With regard to the NavDown event, device 10 has sent a message indicating that the remote user has requested that the RIS workstation application navigate down one record.

With regard to the NavLeft event, device 10 has sent a message indicating that the remote user has requested that the RIS workstation application navigate left one record.

With regard to the NavRight event, device 10 has sent a message indicating that the remote user has requested that the RIS workstation application navigate right one record.

With regard to the NavButton1 event, device 10 has sent a message indicating that the remote user has pressed button #1 on device 10. Similarly, the NavButon2 event indicates that the remote user has pressed button #2 on device 10; the NavButton3 event indicates that the remote user has pressed button #3 on device 10; and the NavButton4 event indicates that the remote user has pressed button #1 on the PDA.

With regard to the ConnectionEstablished event, this event is fired/activated when device 10 has connected to the RIS workstation application.

As to the ConnectionClosed event, this event is fired/activated when device 10 has terminated its connection/communication with the RIS workstation application.

The ListenerClosed event is fired/activated when the connection listener is no longer active. This can occur by means of a request from the RIS workstation application or by a communications error.

The PlayDictation event is fired/activated when device 10 requests that the RIS workstation application start playing the current wave file.

The PauseDictation event is fired/activated when device 10 has requested that the RIS workstation application pause the playing of the current wave file.

The StopDictation event is fired/activated when device 10 requests that the RIS workstation application stop the playing of the current wave file.

The StartRecording event is fired/activated when device 10 starts recording a new dictation. Device 10 preferably initiates this event when there is no previous dictation on the RIS workstation.

The StartRecordinglnsert event is fired/initiated when device 10 starts recording an insert into the current dictation. The inserted dictation will be placed at the StartByte location in the sound file. Device 10 can initiate this event when there is no previous dictation on the RIS workstation.

The StartRecordingOverWrite event is initiated when device 10 starts recording an overwrite on top a portion of the current dictation. In a preferred embodiment, the inserted dictation will be placed at the StartByte location in the sound file, and device 10 can initiate this event when there is no previous dictation on the RIS workstation.

The StopRecording event is fired/activated when device 10 has completed its current recording. It will get fired after an initial recording, an insert recording and an overwrite recording. Device 10 will send this event when substantially all of the sound bytes have been deposited in the remote directory.

The SendComplete event is fired when the current message has been sent from the RIS workstation to device 10.

The RemoteControlEnabled event is fired when device 10 requests remote control of the RIS workstation application.

The RemoteControlDisabled event is fired when the current message has been sent from the RIS workstation application to device 10.

The Log event is fired when ActiveX has information that can be logged. For example, there can be three types of logging messages; Debug, Info and Error. The user can decide which events they wish to see by setting the three logging properties: LogErrorMessages, LogDebugMessages, LogInfoMessages.

The Error event is fired when ActiveX encounters an error.

The software application which operates on device 10 will now be described. More particularly, a software application operates on device 10 to record wave files and communicate with the RIS workstation workstation. Device 10 can connect to the RIS workstation network by means of a wireless hub, as previously shown in FIG. 2. For example, the wireless connection can currently occur at 11 Mbps.

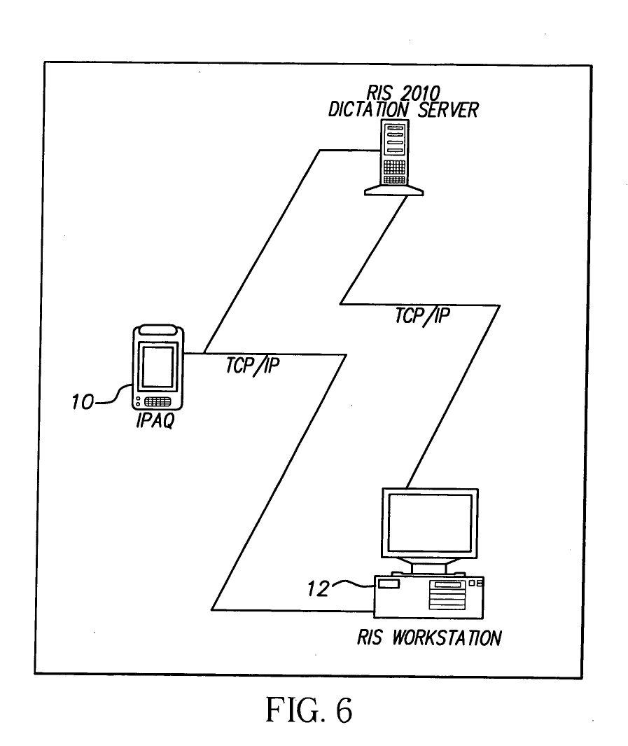

Though device 10 is connected to the RIS network, it does not need access to all of the machines/workstations on the network. Device 10 acts as a remote connection device to a particular RIS workstation and through that workstation it performs remote dictation. The method by which device 10 integrates/communicates with the RIS network may differ from install to install, but a suitable connectivity is shown in FIG. 6.

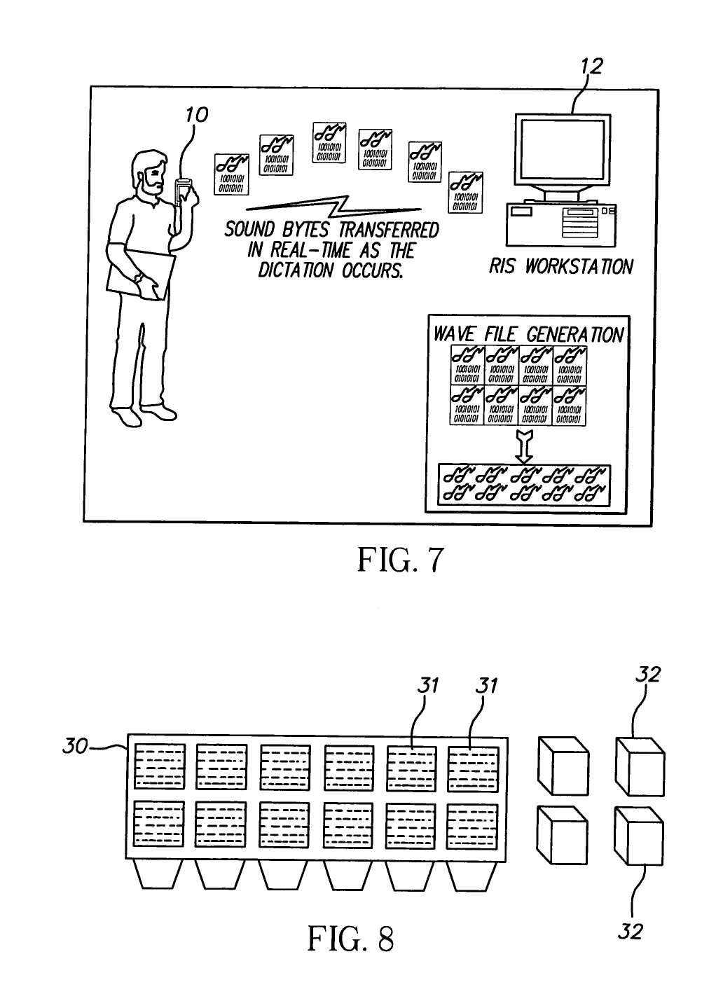

Referring now to FIG. 7, the present invention can provide portable real-time recording, with the voice being recorded both locally and remotely on a RIS system. To perform speech recognition on the dictation, the quality of the recorded voice files must be sufficiently high. Due to the size of the files of these recordings, Applicant has determined that copying the files after the dictation has been completed would not be suitable since the user would be waiting (i.e., minutes or tens of minutes) for the wave file to be transferred to the RIS system. To accomplish real-time wireless dictation, the recorded voice is changed into sound bytes. These sound bytes are, in turn, transferred as small data packets to the RIS system machine (i.e., host system) in real-time. Upon completion of the dictation these sound bytes are then re-assembled by the host system to generate the complete dictation.

To the PDA (i.e., device 10) application, the sound bytes are viewed as memory blocks. To promote the efficiency of the application, these memory blocks are organized/arranged/configured in a matrix. As the recording starts, the application allocates a row of memory blocks to the dictation and formats the memory blocks for voice data. As the dictation continues, these memory blocks get filled with voice data. The application takes these voice-filled data blocks and transfers them one at a time to the host (RIS) system. The host system then checks to see if enough data blocks are in reserve for the application to use. If there are not enough blocks, the application allocates and prepares another row of voice-ready data blocks.

An analogy for this is an ice cube tray 30, as illustrated in FIG. 8. When a user presses the record button, the application of device 10 creates an ice cube tray. As the user speaks, they fill the individual cubes 31 with water. When one cube is full, the application moves to the next individual ice cube and starts filling it. When the individual cubes become full, the application freezes them 32 and sends them to the host system. As the tray becomes full the application allocates another tray and the process is repeated.

When the user has finished dictating, the application assembles these mermory blocks into a complete wave file. This is done on both the PDA and the remote host system allowing the wave file to be present in its entirety both locally on device 10 and remotely on the host RIS workstation.

In one embodiment of the present invention, the device application includes three screens that divide the applications functionality into connection, navigation, and recording. These functionalities are now described.

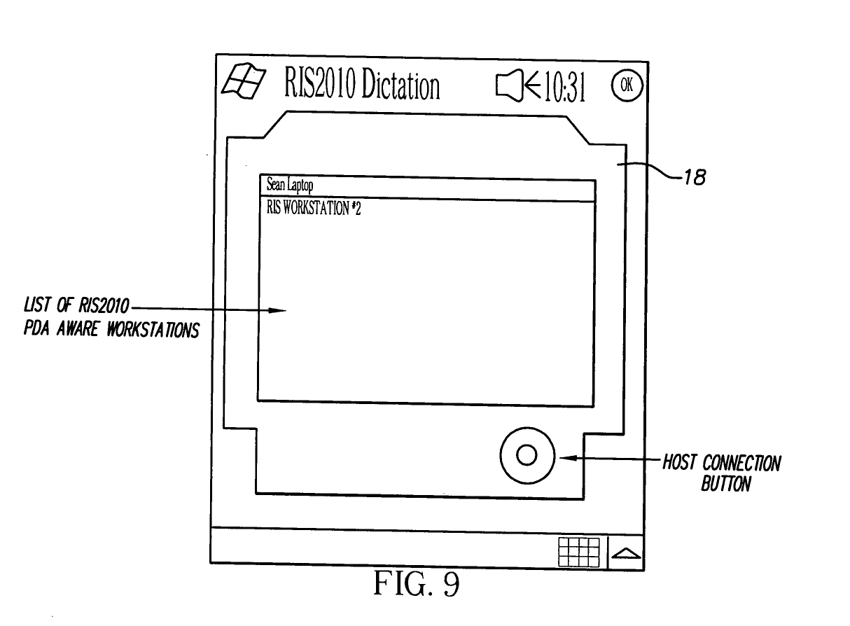

Referring now to FIG. 9, the Connection screen presents the user with a list of RIS workstations adapted to communicate with device 10. The configuration of the RIS workstation listing is discussed below. Once the user connects to a particularl RIS workstation, the application moves to the Navigation screen. It is preferred that device 10 be configured such that, if at any time device 10 loses its connection with the RIS workstation, the application will bring up the Connection screen.

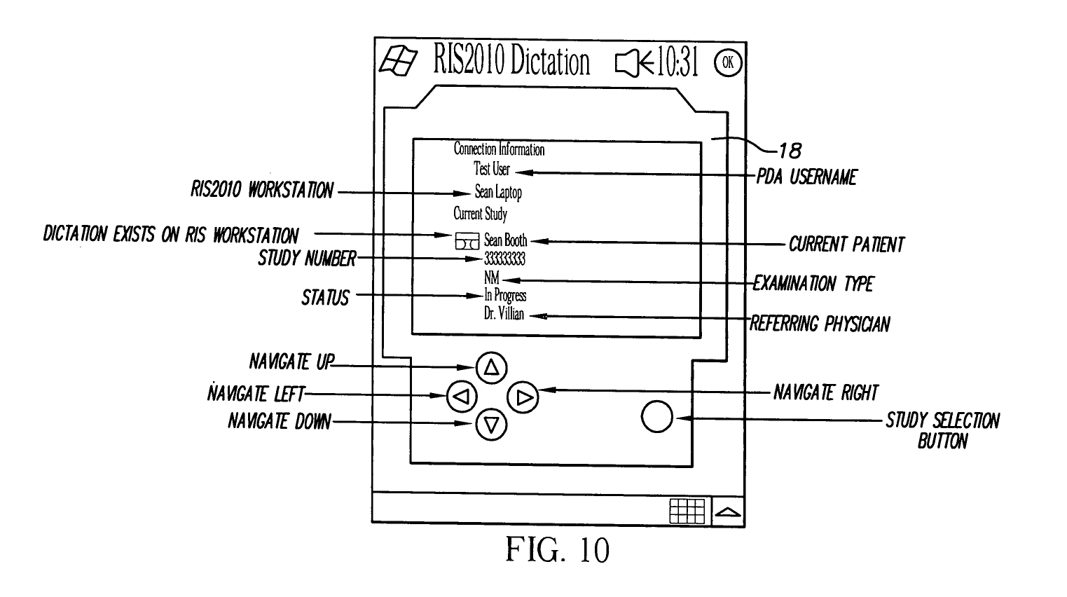

The navigation screen allows a user to navigate through patients and studies on the RIS workstation. In a preferred embodiment, device 10 includes a plurality of selection members, such as four arrow buttons as shown in FIG. 10. As illustrated, four buttons are shown at the bottom and are employed to send navigational commands to the RIS workstation (i.e., the host system). The RIS workstation can respond by sending the current study information. A visual indicator can be employed to indicate to the user whether a dictation currently exists for the selected study.

It is recognized that, for the present invention, the selection members can be physical buttons or display 18 can be configured as a touchscreen. When configured as a touchscreen, the selection members can be disposed on display 18 whereby the user can “touch” the selection member to activate/select a function/feature. Such a configuration allows the number of selection members to change/modify as needed for the particular feature.

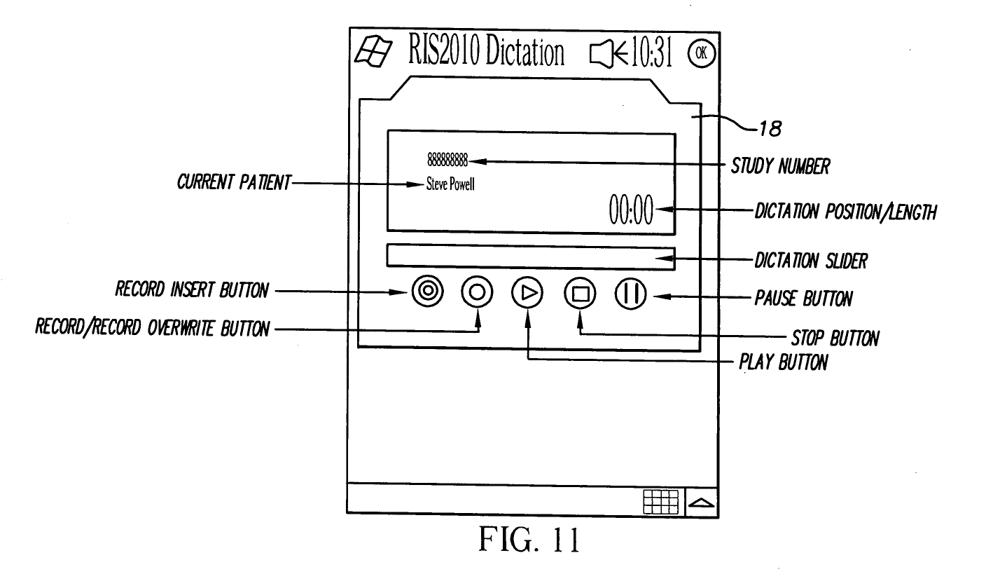

Referring now to FIG. 11, the Recorder allows the user to either control a dictation which is present on the host system, or record a dictation locally on device 10. These features are now more particularly described.

If no dictation exists for the current sudy on the host RIS workstation, device 10's application allows the user to record a dictation locally. As the screen appears, the recorder control enables the record button. By pressing the record button, the user is able to record a dictation. As the dictation is being recorded the application sends the recorded sound bytes to the host RIS workstation. When the user has completed his dictation, the sound bytes are recompiled on the host workstation as well as locally on device 10. The dictation is then present in its entirety on both device 10 and the RIS workstation.

When a dictation is present locally, device 10 can present the user with a plurality of functionality, including but not limited to: play, stop, pause, record, reord over, record insert, playback, and remote dictation control.

In a preferred arragement, the Play button will play the dictation locally.

The stop button stops the current recorder action. It can be used either when the dictation is playing or when the dictation is recording. After pressing the Stop button the dictatiion is moved to the start of the recording.

The pause button can be used when the recording is being played back. The user can pause the dictation at the current position. This allows the user to perform a recording overwrite or insertion at the current position.

The Record Over button gives the user the functionality to record over the existing dictation from the current position. Everything from the start of the current dictation position to the end of the dictation is erased and the the new dictation replaces it. The sound bytes for a Record Over are also dynamically sent to the host system to allow for real-time recording.

The Record Insert button allows the user to insert a recording into the current dictation. The dictation is inserted at the current recording position. The sound bytes for a Record Insert are dynamically sent to the host system to allow for real-time recording.

The slider allows the user to select a location in the recording to start playback. By clicking on the slider the recorder will start playing at the relative dictation location.

With remote dictation control, if a dictation is present on the RIS workstation, the user is not able to record a dictation on device 10. The user can however playback the dictation on the RIS workstation. A play, stop, and pause button can be employed to effect remote dictation control.

With regard to the configuration of the RIS Dictation application on device 10, much of the configuration takes place during the installation process. For example, the initialization files include the customizable configuration information for the RIS Dictation application. The settings for the configuration file include the language to be used for the application, the character sequence to identify device 10, an error log, a setting to define the location of the host RIS workstation, and the like known to those skilled in the art.

Of particular interest is the LocalWaveFileLocation setting which allows the user to define where to perform local wave file manipulations. This can be set to the application directory or to a directory on an external card to preserve system memory.

Also of interest is the RemoteWaveFileLocation setting. This setting can point to a network share that is also used by the host RIS workstation. It may a share on the workstation itself, or more commonly on the RIS Dictation Server. Device 10 accesses the network share.

Another setting of interest is the NUM_BUFFERS setting. This setting is a configuration setting for the real-time transfer of the sound bytes to the host workstation. This property defines the number of buffers that are located in a buffer segment.

Yet another setting of interest is the NUM_BUFFER_SEGMENTS setting. This setting is a configuration setting for the real-time transfer of the sound bytes to the host RS workstation. The setting defines the maximum number of buffer segments to allow. Combined with the NUM_BUFFERS parameter they create a two dimensional array of sound bytes. The array of these sound buffers is allocated to the application as they are required. When multiplied with the NUM_BUFFERS and BUFFER_SIZE settings it preferably equals 26460000, which can provide about ten minutes of maximum recording time.

Still another setting is the BUFFER_SIZE setting. This setting is a configuration setting for the real-time transfer of the sound bytes to the host RIS workstation. The setting defines the size of the sound bytes that are transferred to the RIS Workstation.

A Host file includes connection information for RIS workstations which are aware of device 10. The application reads the host file and uses the information in the host file to connect to the host system.

Those skilled in the art will recognize that the device of the present invention can be employed with various systems requiring remote real-time dictation. As such, while the present invention is described with regard to a RIS system, the present invention is not limited to an interface with a RIS system.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### PARTS LIST

10 device
12 radiology information system (RIS workstation)
14 wireless technology
16 selection member
18 display
20 wireless network hub
22 TCPIP socket
30 ice cube tray
31 individual ice cubes
32 freeze application

1. A system comprising:
a wireless communication device; and
a computer in wireless communication with the wireless communication device adapted to receive a plurality of data packets from the wireless communication device representative of portions of a dictation, the computer comprising means for assembling the plurality of data packets received from the wireless communication device into a wave file representative of the dictation.

2. The system of claim 1, wherein the wireless communication device is configured to receive and record dictation.

3. The system of claim 2, wherein the wireless communication device provides for at least one of the following features: start recording of the dictation, stop recording of the dictation, inserting new dictation, and replaying portions of the recorded dictation.

4. The system of claim 1, wherein the wireless communication device provides at least three functions: connection, navigation, and recording.

5. The system of claim 1, wherein the wireless communication device includes a display adapted to present selection members to a user for operation of the wireless communication device.

6. The system of claim 1, wherein the computer is a Radiology Information System (RIS) workstation.

7. A method of dictation, comprising the steps of:
1) transmitting connection data from a wireless communications device of the user to a remote computer;
2) accepting a portion of the dictation of a user using the wireless communications device;
3) transmitting the accepted portion of the dictation from the wireless communications device to the remote computer;
4) repeating steps 2 and 3 until the dictation has been transmitted to the remote computer; and
5) assembling the plurality of portions received by the remote computer into a wave file representative of the dictation.

8. The method of claim 7, wherein step 5 is accomplished after the completion of step 4.

9. The method of claim 7, wherein the remote computer includes a display, and the method further comprises the step of displaying, on the display, the accepted portions of dictation or the assembled dictation.
